(19) United States
(12) Patent Application Publication
(10) Pub. No.: US 2022/0414459 A1
(43) Pub. Date: Dec. 29, 2022

(54) METHODS, APPARATUSES, DEVICES AND STORAGE MEDIA FOR TRAINING OBJECT DETECTION NETWORK AND FOR DETECTING OBJECT

(71) Applicant: SENSETIME INTERNATIONAL PTE. LTD., Singapore (SG)

(72) Inventors: Bairun WANG, Singapore (SG); Xuesen ZHANG, Singapore (SG); Chunya LIU, Singapore (SG); Jinghuan CHEN, Singapore (SG); Shuai YI, Singapore (SG)

(21) Appl. No.: 17/491,081

(22) Filed: Sep. 30, 2021

Related U.S. Application Data
(63) Continuation of application No. PCT/IB2021/058292, filed on Sep. 13, 2021.

(30) Foreign Application Priority Data
Jun. 28, 2021 (SG) 10202107102Y

(51) Int. Cl. G06N 3/08; G06K 9/62; G06K 9/00

(52) U.S. Cl. CPC G06N 3/08; G06K 9/628; G06K 9/6259; G06K 9/00362

(57) ABSTRACT

Provided are a training and detection method and apparatus of an object detection network and a device and a storage medium. The method of training an object detection network includes: obtaining, by performing object detection for images in an image data set input into the object detection network and for each of one or more objects involved in each of the images, a confidence levels that the object is predicted as each of a plurality of preset categories; for each of the objects, determining reference labeling information of the object with respect to each of the non-labeled categories; for each of the objects, determining loss information that the object is predicted as each of the preset categories; and adjusting a network parameter of the object detection network based on the loss information that each of the objects is predicted as each of the preset categories.

### CROSS REFERENCE TO RELATED APPLICATION

This application is a continuation of International Application No. PCT/IB2021/058292, filed on Sep. 13, 2021, which claims priority to Singaporean Patent Application No. 10202107102Y entitled “METHODS, APPARATUSES, DEVICES AND STORAGE MEDIA FOR TRAINING OBJECT DETECTION NETWORK AND FOR DETECTING OBJECT” and filed on Jun. 28, 2021, all of which are incorporated herein by reference in their entireties.

### TECHNICAL FIELD

The present disclosure relates to computer technologies, and in particular to methods, apparatuses, devices and storage media for training object detection network and for detecting object.

### BACKGROUND

Object detection technologies are important in computer vision field. To improve generality of an object detection network, one object detection network usually needs to support several categories of object detection tasks. In an actual circumstance, a training sample set may not include labels of all object categories detectable by the object detection network. Therefore, it is necessary to adopt several training sample sets (the several training sample sets jointly include labels of all object categories) to perform joint training for the object detection network.

### SUMMARY

In view of this, the present disclosure at least provides a method of training an object detection network, including: obtaining, by performing object detection for images in an image data set input into the object detection network and for each of one or more objects involved in each of the images, a confidence level that the object is predicted as each of a plurality of preset categories; wherein the plurality of preset categories comprise one or more labeled categories labeled by the image data set and one or more non-labeled categories unlabeled by the image data set; for each of the objects, according to a non-concerned confidence level that the object is predicted as each of the non-labeled categories, determining reference labeling information of the object with respect to each of the non-labeled categories; for each of the objects, according to the confidence level that the object is predicted as each of the preset categories, actual labeling information of the object and the reference labeling information of the object with respect to each of the non-labeled categories, determining loss information that the object is predicted as each of the preset categories; and adjusting a network parameter of the object detection network based on the loss information that each of the objects is predicted as each of the preset categories

In some embodiments, determining the reference labeling information of the object with respect to the non-labeled category according to the non-concerned confidence level that the object is predicted as the non-labeled category comprises: in response to that the non-concerned confidence level reaches a preset positive sample confidence level, determining the reference labeling information as first preset reference labeling information; and in response to that the non-concerned confidence level does not reach a preset negative sample confidence level, determining the reference labeling information as second preset reference labeling information; wherein the positive sample confidence level is not smaller than the negative sample confidence level.

In some embodiments, the method further includes: in response to that the non-concerned confidence level reaches the negative sample confidence level but does not reach the positive sample confidence level, determining the reference labeling information of the object with respect to the non-labeled category as third preset reference labeling information.

In some embodiments, the labeled category and the non-labeled categories are determined by: obtaining object categories labeled in the image data set as the labeled categories; for each of the plurality of preset categories, determining the preset category as a current category and: determining whether the current category is matched with one of the labeled categories; and in response to determining that the current category is not matched with any of the labeled categories, determining the current category as a non-labeled category.

In some embodiments, according to the confidence level that the object is predicted as each of the preset categories, actual labeling information of the object and the reference labeling information with respect to each of the non-labeled categories, determining the loss information that the object is predicted as each of the preset categories comprises: for each of the non-labeled categories, determining first loss information that the object is predicted as the non-labeled category based on a difference between a non-concerned confidence level that the object is predicted as the non-labeled category and the reference labeling information; and for each of the labeled categories, determining second loss information that the object is predicted as the labeled category according to a difference between a confidence level that the object is predicted as the labeled category and the actual labeling information of the object.

In some embodiments, adjusting the network parameter of the object detection network based on the loss information that each of the objects is predicted as each of the preset categories comprises: for each of the objects, obtaining total loss information by determining a sum of the first loss information and the second loss information corresponding to the object; determining a descent gradient in a back propagation process according to the total loss information of each of the objects; and adjusting the network parameter of the object detection network through back propagation according to the descent gradient.

In some embodiments, a plurality of image data sets are input into the object detection network, and the labeled categories labeled by at least two of the plurality of image data sets are not identical.

The present disclosure further provides a method of detecting a human body object, including: obtaining a scenario image; obtaining a human body object involved in the scenario image and a confidence level that the human body object is predicted as each of a plurality of preset categories by performing object detection for the scenario image through an object detection network; wherein the object detection network is trained by the method according to any one of the above embodiments; and determining the highest confidence level among respective confidence levels that the human body object is predicted as the plurality of preset categories, and determining a preset category corresponding to the highest confidence level as an object category of the human body object.

In some embodiments, the human body object includes at least one of face, hand, elbow, shoulder, leg and torso; the preset category comprises at least one of: face category, hand category, elbow category, shoulder category, leg category, torso category and background category.

The present disclosure further provides a method of detecting a human body object, including: obtaining a plurality of image sets, wherein object categories labeled in at least two of the plurality of image sets are not identical; by performing object detection for an image of the plurality of image sets through an object detection network, obtaining a human body object involved in the image and a confidence level that the human body object is predicted as each of a plurality of preset categories; wherein the object detection network is trained by the method according to any one of the above embodiments; and determining the highest confidence level among respective confidence levels that the human body object is predicted as the plurality of preset categories, and determining a preset category corresponding to the highest confidence level as an object category of the human body object.

The present disclosure further provides an apparatus for training an object detection network, including: a detecting module, configured to obtain, by performing object detection for images in an image data set input into the object detection network and for each of one or more objects involved in each of the images, a confidence levels that the object is predicted as each of a plurality of preset categories; a first determining module, configured to according to labeled categories labeled by the image data set among the plurality of preset categories, determine non-labeled categories unlabeled by the image data set among the plurality of preset categories; a second determining module, configured to for each of the objects, according to a non-concerned confidence level that the object is predicted as each of the non-labeled categories, determine reference labeling information of the object with respect to each of the non-labeled categories; a third determining module, configured to for each of the objects, for each of the objects, according to the confidence level that the object is predicted as each of the preset categories, actual labeling information of the object and the reference labeling information of the object with respect to each of the non-labeled categories, determine loss information that the object is predicted as each of the preset categories; and an adjusting module, configured to adjust a network parameter of the object detection network based on the loss information that each of the objects is predicted as each of the preset categories.

The present disclosure further provides an apparatus for detecting a human body object, including: a first obtaining module, configured to obtain a scenario image; a first predicting module, configured to obtain a human body object involved in the scenario image and a confidence level that the human body object is predicted as each of a plurality of preset categories by performing object detection for the scenario image through an object detection network; wherein the object detection network is trained by the method according to any one of the above embodiments; and a first object category determining module, configured to determine the highest confidence level among respective confidence levels that the human body object is predicted as the plurality of preset categories, and determine a preset category corresponding to the highest confidence level as an object category of the human body object.

The present disclosure further provides an apparatus for detecting a human body object, including: a second obtaining module, configured to obtain a plurality of image sets, wherein object categories labeled in at least two of the plurality of image sets are not identical; a second predicting module, configured to by performing object detection for an image of the plurality of image sets through an object detection network, obtain a human body object involved in the image and a confidence level that the human body object is predicted as each of a plurality of preset categories; wherein the object detection network is trained by the method according to any one of the above embodiments; and a second object category determining module, configured to determine the highest confidence level among respective confidence levels that the human body object is predicted as the plurality of preset categories, and determine a preset category corresponding to the highest confidence level as an object category of the human body object.

The present disclosure further provides an electronic device, including a memory, a processor and computer instructions stored in the memory and run on the processor, wherein the computer instructions are capable of executed by the processor to implement the method according to any one above embodiment.

The present disclosure further provides a computer readable storage medium storing computer programs thereon, wherein the programs are executed by a processor to implement the method according to any one above embodiment.

In the above technical solution, In the above technical solution, confidences level that objects involved in each of the images are predicted as each of a plurality of preset categories may be obtained by performing object detection for the images in an image data set input into an object detection network; wherein the plurality of preset categories comprise one or more labeled categories labeled by the image data set and one or more non-labeled categories unlabeled by the image data set; according to non-labeled confidences that the objects are predict as each of the non-labeled categories, reference labeling information is determined; according to confidence levels that the objects are predicted as each of the preset categories, actual labeling information of the object and the reference labeling information with respect to each of the non-labeled categories, loss information that the objects are predicted as each of the preset categories is determined, and a network parameter of the object detection network is adjusted based on the loss information

Therefore, the reference labeling information corresponding to a detected object may be added in response to that the detected object is predicted as an unlabeled category, so that accurate loss information can be determined based on the added reference labeling information during network training so as to enable the network to learn accurate information, thereby improving network detection accuracy and reducing misreporting rate.

It is to be understood that the above general descriptions and the subsequent detailed descriptions are merely exemplary and explanatory, and are not intended to limit the present disclosure.

### BRIEF DESCRIPTION OF THE DRAWINGS

For clearer descriptions of the technical solutions in one or more embodiments of the present disclosure or in the related art, accompanying drawings to be used in the descriptions of the embodiments or in the related art will be briefly introduced below. It is apparent that the accompanying drawings described below are merely some embodiments in one or more embodiments of the present disclosure, and other drawings may also be obtained by those of ordinary skill in the art based on these drawings without paying creative work.

FIG. 1 is a flowchart of a method of training an object detection network according to one or more embodiments of the present disclosure.

FIG. 2 is a flowchart of a method of determining loss information according to one or more embodiments of the present disclosure.

FIG. 3 is a flowchart of a method of training an object detection network according to one or more embodiments of the present disclosure.

FIG. 4 is a flowchart of a method of determining sub-loss information according to one or more embodiments of the present disclosure.

FIG. 5 is a flowchart of a method of detecting a human body object according to one or more embodiments of the present disclosure.

FIG. 6 is a flowchart of a method of detecting a human body object according to one or more embodiments of the present disclosure.

FIG. 7 is a structural schematic diagram of an apparatus for training an object detection network according to one or more embodiments of the present disclosure.

FIG. 8 is a hardware structural schematic diagram of an electronic device according to one or more embodiments of the present disclosure.

### DETAILED DESCRIPTION OF THE EMBODIMENTS

Embodiments will be described in detail herein, with the illustrations thereof represented in the drawings. When the following descriptions involve the drawings, like numerals in different drawings refer to like or similar elements unless otherwise indicated. Implementations described in the following embodiments do not represent all implementations consistent with the present disclosure. Rather, they are merely examples of devices and methods consistent with some aspects of the present disclosure as detailed in the appended claims.

The terms used in the present disclosure are for the purpose of describing particular embodiments only, and are not intended to limit the present disclosure. Terms “a”, “the” and “said” in their singular forms in the present disclosure and the appended claims are also intended to include plurality, unless clearly indicated otherwise in the context. It should also be understood that the term “and/or” as used herein refers to and includes any and all possible combinations of one or more of the associated listed items. It should also be understood that the word “if” as used herein, depending on the context, may be interpreted as “when” or “as” or “determining in response to”.

A joint training method in the related arts will be described below by taking a human body detection scenario as an example.

In the above scenario, an object detection network (hereinafter called detection network) may detect face object, hand object, and elbow object involved in a target image.

In the above scenario, the detection network may be trained by using an image data set 1 and an image data set 2. The data set 1 involves objects labeled as face category and hand category. The data set 2 involves objects labeled as face category and elbow category. In some embodiments, the labeling may be performed by one-hot encoding. For example, in the data set 1, the labeling information of the object of face category may be [1, 0, 0], which means that a true value that the object is predicted as the face category is 1 and a true value that the object is predicted as the hand category is 0, and a true value that the object is predicted as a background category is 0. For another example, the labeling information of the object of hand category may be [0, 1, 0] which means that the true value that the object is predicted as the face category is 0, the true value that the object is predicted as the hand category is 1, and the true value that the object is predicted as the background category is 0.

As can be understood, one the one hand, each of the data set 1 and the data set 2 does not include labels of all object categories detectable by the detection network whereas both the data set 1 and the data set 2 jointly include labels of all object categories detectable by the detection network. On the other hand, an unlabeled object in the data set 1 and the data set 2 may be classified as a background category, that is, actual labeling information corresponding to the unlabeled object is [0, 0, 1]. For example, the actual labeling information corresponding to the unlabeled elbow object in the data set 1 is [0, 0, 1].

During the training process, the detection network may be trained based on the data set 1 and the data set 2. It should be noted that the structure of the detection network is not limited herein.

In an iteration of training, a detection box of each object involved in the data set 1 and data set 2 and a category detection result of the object in the detection box may be obtained by inputting the obtained data sets 1 and 2 into the object detection network, where the category detection result includes corresponding confidence levels that the object is predicted as a plurality of preset categories such as face object, hand object, elbow object and background and the like.

Then, for each detected detection box, the face category, the hand category, the elbow category and the background category are determined as current categories respectively and sub-loss information that the object in the detection box is predicted as the current category is determined.

When the above sub-loss information is determined, it may be determined whether the above current category is matched with an object category labeled in the image in which the object in the above detection box involves.

If the current category is matched with the object category labeled in the image data set, sub-loss information that the category of the object in the detection box is predicted as the current category is determined based on the actual labeling information of the object and the confidence level of the object in the detection box.

If the current category is not matched with the object category labeled in the image data set, the sub-loss information is set to 0.

For example, for a detection box 1 of one object detected by the object detection network, an object in the detection box is an unlabeled elbow object in the data set 1. The labeling information of the object includes [0, 0, 1], that is, the true value that the object is predicted as face is 0, the true value that the object is predicted as hand is 0, and the true value that the object is predicted as background is 1. If the category detection result of the object in the detection box 1 includes [0.1, 0.1, 0.7, 0.1], the confidence level that the object is face is 0.1, the confidence level that the object is hand is 0.1, the confidence level that the object is elbow is 0.7, and the confidence level that the object is background is 0.1.

Since the data set 1 includes labels of the face category, the sub-loss information that the object is predicted as face may be determined based on the true value 0 that the object is predicted as face and the confidence level 0.1 that the object is predicted as face.

Since the data set 1 includes labels of the hand category, the sub-loss information that the object is predicted as hand may be determined based on the true value 0 that the object is predicted as hand and the confidence level 0.1 that the object is predicted as hand.

Since the data set 1 does not include labels of the elbow category, it is not necessary to consider the sub-loss information that the object is predicted as elbow, that is, the sub-loss information that the object is predicted as elbow may be set to 0.

Since the data set 1 include labels of the background category, the sub-loss information that the object is predicted as background may be determined based on the true value 1 that the object is predicted as background and the confidence level 0.1 that the object is predicted as background.

After loss information that the object in the detection box is predicted as the object categories respectively is determined, a sum of the determined loss information corresponding to the object categories is determined as loss information corresponding to the object in the detection box, where the loss information of the object in the detection box represents a difference between the category detection result and the actual labeling information of the object in the detection box.

After the loss information corresponding to the object in each detection box is determined, a sum of the loss information corresponding to the objects in the detection boxes detected in the image may be determined as total loss information of this round of iteration, and the network parameter of the detection network is adjusted based on the total loss information.

Finally, the above iteration process can be repeated until the detection network converges to complete training.

As can be understood, in the related art, the loss information that the object in the image is predicted as a non-labeled category in the image data set in which the image involves is set to 0. The closer the loss information is to 0, the more accurate the detection result will be. During the training process, a neural network usually updates the parameter with target loss information close to 0. As a result, in an iteration of the training process, it is possible that the unlabeled objects are classified into the non-labeled category (non-background category) rather than classified into the background category. Actually, the unlabeled objects shall be classified into the background category. Thus, in the related art, the detection network will learn inaccurate information due to introduction of inaccurate loss information, leading to a high misreporting rate of the detection network.

For example, in the example in which the loss information corresponding to the detection box 1 is determined, the object included in the detection box 1 is the elbow object (unlabeled object). At this time, the object shall be classified into the background category. However, in the above example, the object is classified into the non-labeled category in the image. Thus, in the related art, the detection network may learn inaccurate information due to introduction of inaccurate loss information, leading to a high misreporting rate of the detection network.

In view of this, the present disclosure provides a method of training an object detection network. In this method, in response to that the detected object is predicted as a non-labeled category, reference labeling information of the object is introduced, such that accurate loss information can be determined based on the reference labeling information during network training. Thus, the network can learn accurate information, thereby improving the network detection accuracy and lowering the misreporting rate.

The non-labeled category may refer to an object category that that can be predicted by the object detection network but not labeled in the image in which the object involves.

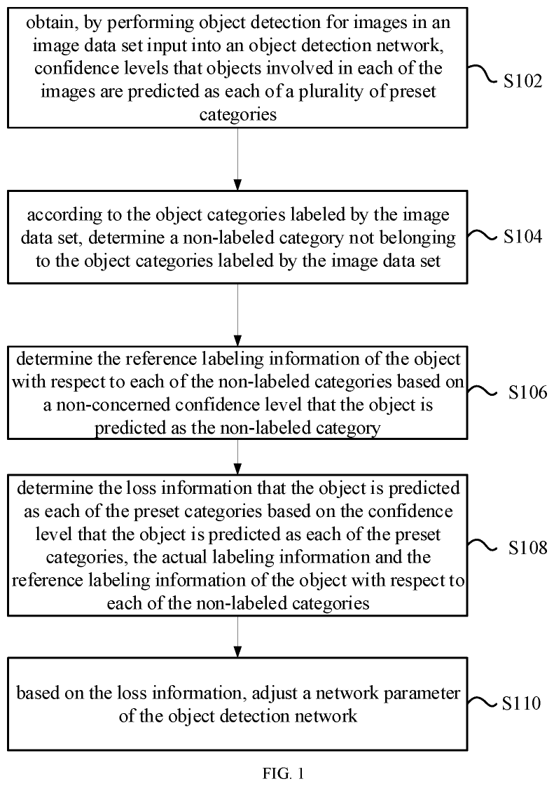

FIG. 1 is a flowchart of a network training method according to the present disclosure.

The training method shown in FIG. 1 may be applied to an electronic device. The above electronic device may perform the above training method using a software system corresponding to the training method. It should be noted that the above electronic device may be a laptop computer, a computer, a server, a mobile phone, a PAD terminal and the like, which is not limited in the present disclosure. The above electronic device may also be a client device or a server device, which is not limited herein.

As shown in FIG. 1, the method may include the following steps.

At step S102, by performing object detection for images in an image data set input into an object detection network, confidence levels that objects involved in each of the images are predicted as each of a plurality of preset categories are obtained. The plurality of preset categories include all object categories detectable by the object detection network, for example, an object category labeled by the image data set (hereinafter referred to labeled category) and an object category unlabeled by the image data set (hereinafter referred to non-labeled category). Correspondingly, confidence levels that an object is predicted as each of the plurality of preset categories include confidence levels that the object is predicted as labeled categories (hereinafter referred to concerned confidence) and confidence levels that the object is predicted as non-labeled categories (hereinafter referred to unconcerned confidence).

The object detection network may be used to perform object detection for an image. For example, the object detection network may be a human body object detection network. At this time, a human body object involved a target image can be detected by the detection network. The detection network may be a network constructed based on Region Convolutional Neural Networks (RCNN), Fast Region Convolutional Neural Networks (FAST-RCNN) or Faster Region Convolutional Neural Networks (FASTER-RCNN). It is noted that the network structure of the object detection network is not limited herein.

An output result of the object detection network may be a confidence level that an object involved in an input image is predicted as each of the preset categories.

The preset categories may be preset by developers according to actual requirements. If the object detection network needs to detect face, hand, and elbow objects present in the image, the preset categories may be set to face category, hand category, elbow category and background category.

The images input into the object detection network may include images in a plurality of image data sets, where object categories labeled in at least two image data sets in the plurality of image data sets are different.

The image data set may include a plurality of labeled image samples. The labeled object categories in the image may include only some of the preset categories. For example, if the preset categories include face category, hand category, elbow category and background category, the labeled object categories in the image may only be face category or hand category.

Currently, an image data set having partial labeled object categories have been widely applied. In the present disclosure, the object detection network may be trained using the image data set. Further, an object detection network for a plurality of object categories may be trained by fusing a plurality of image data sets having labeling information of different object categories, so as to reduce the training costs.

The confidence level represents a reliability degree that an object detected in an image is predicted as each of the preset categories, which is expressed by a probability value. The loss information corresponding to the detection result of the object detection network for the object may be determined according to a difference between the labeling information and the confidence level.

In some examples, in step S102, an object involved in each image data set and a category detection result of the object may be obtained by inputting the images of a plurality of image data sets into the object detection network for calculation.

Then, the step 104 may be performed: according to the object categories labeled by the image data set, a non-labeled category not belonging to the object categories labeled by the image data set is determined.

The labeled category may specifically be an object category labeled by the image data set. In some examples, when an image data set is constructed, object category information labeled for the image data set may be packaged into the image data set. At this time, the object category labeled in the image in the image data set may be determined by obtaining the labeled object category information.

The non-labeled category may specifically be a category not belonging to the labeled category in the plurality of preset categories. For example, the plurality of preset categories may include face category, hand category, elbow category and background category. The labeled object categories labeled by the image data set include face category, hand category and background category. Thus, the elbow category in the preset categories is the non-labeled category.

In some examples, when determining non-labeled categories, the object categories labeled by the image data set are obtained as the labeled categories. Then, each of the preset categories is determined as a current category and the following operations are executed: determining whether the current category is matched with one of the labeled categories; if not, determining the current category as a non-labeled category.

In some examples, the same object category may be represented by a same identifier, and thus different object categories may be represented by different identifiers. At this time, whether the current category is matched with one of the labeled categories can be determined by determining whether the identifier of the current category is consistent with the identifier corresponding to one of the labeled categories.

Thus, the non-labeled category in the preset categories may be determined, and then the reference labeling information that the object is predicted as the non-labeled category is determined, so as to obtain accurate loss information and improve the network training effect.

After the non-labeled category is determined, the step S106 can be performed: the reference labeling information of the object with respect to each of the non-labeled categories is determined based on a non-concerned confidence level that the object is predicted as the non-labeled category.

The reference labeling information of the object with respect to the non-labeled category may be information virtually labeled for the object when it is predicted as the non-labeled category.

If the object is predicted as an unlabeled category (the non-labeled category), it is possible that the accurate loss information cannot be determined due to unavailability of the labeling information corresponding to the object. Therefore, in the related art, the loss information may be set to 0, that is, no consideration is given to the loss that the object is predicted as the non-labeled category, which may introduce wrong loss information during model training. In the present disclosure, when an object is predicted as the non-labeled category, the reference labeling information virtually labeled for the object so that more accurate loss information is introduced, thereby improving the network training effect.

In some examples, whether the object is a positive sample or negative sample of the non-labeled category may be determined based on the non-concerned confidence level that the object is predicted as the non-labeled category.

If it is the positive sample, it may be determined that the reference labeling information is first preset reference labeling information (empirical threshold). For example, the first preset reference labeling information may be 1.

If it is the negative sample, it may be determined that the reference labeling information is second preset reference labeling information (empirical threshold). For example, the second preset reference labeling information may be 0.

In some examples, when determining whether the object is a positive sample or a negative sample of the non-labeled category, the object category of the object may be obtained by predicting the object category of the object (unlabeled object) by using a trained object category determining network, where the object category determining network may be understood as a teacher model, that is, the model can be obtained through training by using several training samples labeled with the preset categories.

If the object category of the object obtained through the object category determining network is consistent with the non-labeled category, it is determined that the object is the positive sample.

If the object category of the object obtained through the object category determining network is inconsistent with the non-labeled category, it is determined that the object is the negative sample.

In some examples, a first preset threshold may be set. When the non-concerned confidence level that the detected object is the non-labeled confidence reaches the first preset threshold, it is determined that the object is the positive sample, and otherwise, is the negative sample.

In some examples, a second preset threshold may be set. When the non-concerned confidence level does not reach the second preset threshold, it is determined that the object is the negative sample, and otherwise is the positive sample.

By performing threshold determination for the non-concerned confidence level, time and computation overhead of determining the true value are reduced, the efficiency of determining the true value is increased, thus improving the network training efficiency.

In some examples, a positive sample confidence level and a negative sample confidence level may be set. When the confidence level reaches the positive sample confidence level, it is determined that the object is the positive sample. If the confidence level does not reach the negative sample confidence level, it is determined that the object is the negative sample.

In this example, by setting the positive sample confidence level and the negative sample confidence level, more accurate positive sample and negative sample can be determined, thus providing more accurate information to the network training and increasing the network detection accuracy.

In some examples, in response to that the non-concerned confidence level reaches the negative sample confidence level but does not reach the positive sample confidence level, it is determined that the reference labeling information is third preset reference labeling information.

The third preset reference labeling information may be an empirical threshold. In some embodiments, the empirical threshold may be set to 0.

In this example, the class of the object may also include a difficult sample as well as the positive sample and the negative sample. The loss information that the object is the difficult sample is set to the third preset reference labeling information (for example, 0). Therefore, in a network training process, the information provided by the difficult sample may not be learned, that is, only the information provided by the positive sample and the negative sample is learned, so as to provide more accurate information for the network training and improve the network detection accuracy.

After the reference labeling information that the object is predicted as the non-labeled category is determined, the step S108 may be performed: the loss information that the object is predicted as each of the preset categories is determined based on the confidence level that the object is predicted as each of the preset categories, the actual labeling information of the object and the reference labeling information of the object with respect to each of the non-labeled categories.

The loss information may be determined in two ways according to whether an object category is predicted as unlabeled category (non-labeled confidence).

In some examples, in response to that the object is predicted as the non-labeled confidence, first loss information that the object is predicted as the non-labeled confidence is determined based on a difference between the non-concerned confidence level and the reference labeling information.

For example, the first loss information may be obtained by taking the non-concerned confidence level and the reference labeling information as input according to a preset first loss function. It should be noted that the specific category of the first loss function is not limited herein.

In some examples, in response to that the object category is predicted as a labeled category, second loss information that the object is predicted as the labeled category is determined based on a difference between a confidence level that the object is predicted as the labeled category and the actual labeling information corresponding to the object. The labeled category includes a category other than the non-labeled confidence in the preset categories.

For example, firstly, a true value that the object is predicted as the labeled category is obtained based on the actual labeling information of the image to which the object belongs, and then the second loss information is obtained by taking the confidence level that the object is predicted as the labeled category and the true value that the object is predicted as the labeled category as input according to a preset second loss function. It should be noted that the specific category of the second loss function is not limited herein.

At step S110, based on the loss information, a network parameter of the object detection network is adjusted.

In some embodiments, for each of the objects in the image, total loss information obtained by detecting the image may be obtained by determining a sum of the first loss information and the second loss information corresponding to the object.

Afterwards, a descent gradient in a back propagation is determined based on the total loss information, and then the network parameter of the object detection network is adjusted based on the descent gradient through back propagation.

In some examples, the image may involve a plurality of objects. The detection network may detect objects of multiple preset categories. At this time, the detection box of each object in the image and the confidence level that each object is predicted as each of the preset categories are obtained by sequentially inputting the images into the detection network.

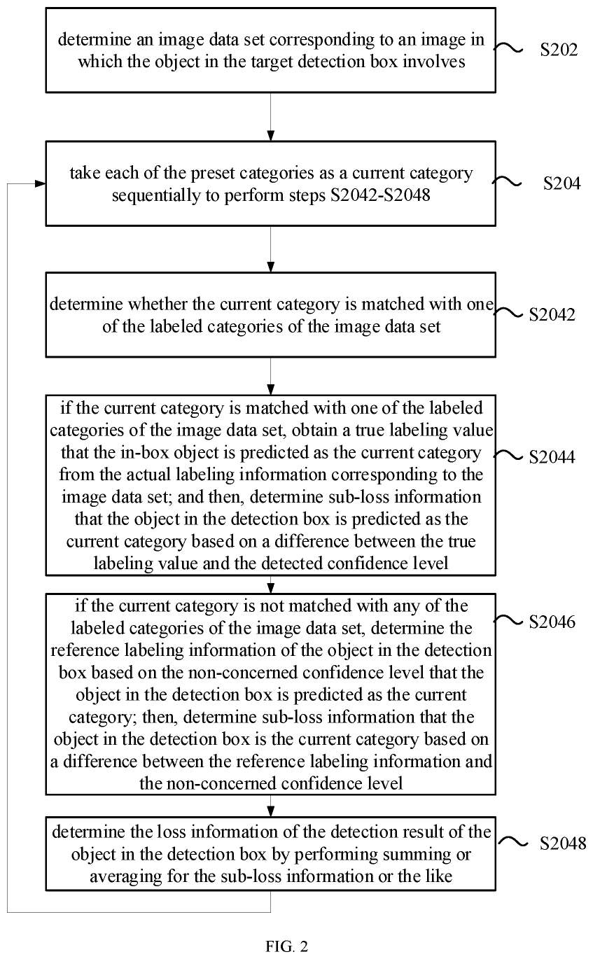

FIG. 2 shows a flowchart of a method of determining loss information according to the present disclosure.

As shown in FIG. 2, the detected detection boxes corresponding to a plurality of objects are sequentially taken as a target detection box to perform steps S202 and S204.

At step S202, an image data set corresponding to an image in which the object in the target detection box involves is determined. The object in the target detection box is referred to as an object in the detection box below.

At step S204, each of the preset categories is taken as a current category sequentially to perform steps S2042-S2048.

At step S2042, it is determined whether the current category is matched with one of the labeled categories of the image data set.

At step S2044, if the current category is matched with one of the labeled categories of the image data set, a true labeling value that the object in the detection box is predicted as the current category is obtained from the actual labeling information corresponding to the image data set; and then, sub-loss information that the object in the detection box is predicted as the current category is determined based on a difference between the true labeling value and the detected confidence level.

At step S2046, if the current category is not matched with any of labeled categories of the image data set, the reference labeling information of the object in the detection box is determined based on the non-concerned confidence level that the object in the detection box is predicted as the current category; then, sub-loss information that the object in the detection box is the current category is determined based on a difference between the reference labeling information and the non-concerned confidence level.

After the corresponding sub-loss information that the object in the detection box is predicted as each object category, the step S2048 may be performed: the loss information of the detection result of the object in the detection box is determined by performing summing or averaging for the sub-loss information or the like.

The loss information of the detection result obtained by performing detection for the image may be obtained after the above step is completed with each detection box in the image as a target detection box.

In some examples, when the training sample set of the object detection network is a plurality of image data sets, the total loss information corresponding to each image input into the each image data set may also be determined after determining the total loss information obtained by performing detection for the image; and then, the total loss information of the detection results obtained by performing detection for the images in the each image data set is determined by summing or averaging or the like, and the network parameter is updated using the total loss information.

Thus, one round of training for the object detection network is completed. Then, multiple rounds of training can be performed by repeating the above steps until the detection network converges. It should be noted that the convergence condition may be that a preset number of trainings are reached or a change amount of a joint learning loss function obtained after M successive forward propagations is smaller than a particular threshold or the like, where M is a positive integer greater than 1. It should be noted that the condition of model convergence is not limited herein.

In the above technical solution, confidences level that objects involved in each of the images are predicted as each of a plurality of preset categories may be obtained by performing object detection for the images in an image data set input into an object detection network; wherein the plurality of preset categories comprise one or more labeled categories labeled by the image data set and one or more non-labeled categories unlabeled by the image data set; according to non-labeled confidences that the objects are predict as each of the non-labeled categories, reference labeling information of the object with respect to each of the non-labeled categories is determined; according to confidence levels that each of the objects is predicted as each of the preset categories, actual labeling information of each of the objects and the reference labeling information of each of the objects with respect to each of the non-labeled categories, loss information that each of the objects is predicted as each of the preset categories is determined, and a network parameter of the object detection network is adjusted based on the loss information.

Therefore, the reference labeling information corresponding to a detected object may be added in response to that the detected object is predicted as a non-labeled category, so that accurate loss information can be determined based on the added reference labeling information during network training so as to enable the network to learn accurate information, thereby improving network detection accuracy and reducing misreporting rate.

Descriptions are made below to the embodiments of the present disclosure in combination with a training scenario of a human body detection network.

The human body detection network is specifically used to detect a face object, a hand object and an elbow object contained in a target image. The human body detection network may be a detection network constructed based on FASTER-RCNN.

In the above scenario, the detection network may be trained by using an image data set 1 and an image data set 2. As can be understood, more data sets may be used in actual applications.

The data set 1 includes labels of objects of face category and hand category. The data set 2 includes labels of objects of face category and elbow category.

In some examples, the labeling may be performed by one-hot encoding. For example, in the data set 1, the labeling information of the object of face category may be [1, 0, 0], which means that a confidence level that the object is predicted as the face category is 1, a confidence level that the object is predicted as the hand category is 0, and a confidence level that the object is predicted as a background category is 0. For another example, the labeling information of the object of hand category may be [0, 1, 0], which means that the confidence level that the object is predicted as the face category is 0, the confidence level that the object is predicted as the hand category is 1, and the confidence level that the object is predicted as the background category is 0.

As can be understood, the object of elbow category is unlabeled in the data set 1, so that the elbow category may be a non-labeled category corresponding to the data set 1. The object of hand category is unlabeled in the data set 2, so that the hand category may be a non-labeled category corresponding to the data set 2.

In the present disclosure, the number of training iterations may be preset to P, an initial network parameter of the detection network is Q, a loss function is L, and the network parameter may be adjusted by a stochastic gradient descent algorithm.

A positive sample confidence level E and a negative sample confidence level F may also be preset. When a confidence level that the object is predicted as the non-labeled category reaches E, it may be thought that the object is a positive sample, and the corresponding reference labeling information is 1. When the confidence level that the object is predicted as the non-labeled category does not reach F, it may be thought that the object is a negative sample, and the corresponding reference labeling information is 0. If the confidence level that the object is predicted as the non-labeled category is between E and F, it may be thought that the object is a difficult sample.

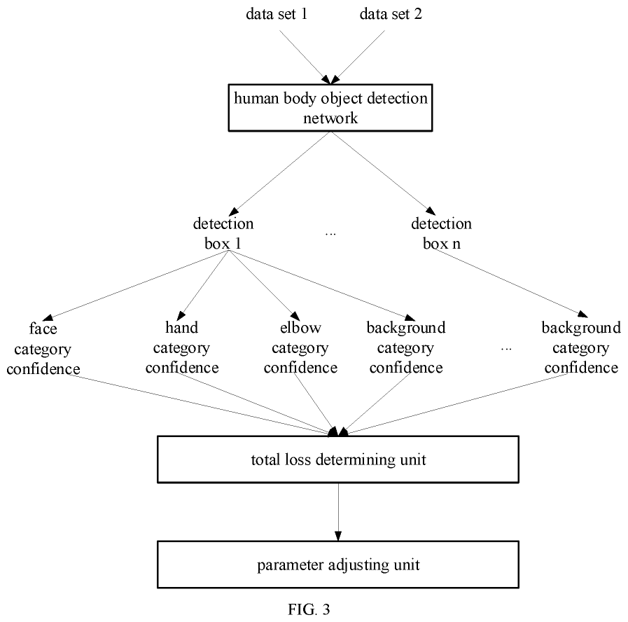

FIG. 3 is a flowchart of a method of training a network according to one or more embodiments of the present disclosure. It is to be noted that FIG. 3 shows a method of adjusting a network parameter in one round of iterative training.

As shown in FIG. 3, in one round of iterative training, step S302 may be performed through a human body object detection network: a detection box corresponding to each object included in each image and the confidence level that the object in each detection box is predicted as face category, hand category, elbow category and background category may be obtained by inputting different images included in the data set 1 and the data set 2 into the detection network at one time for calculation.

Then, step S304 may be performed by a total loss determining unit: total loss information corresponding to this round of training is determined.

When the total loss information is determined, each detection box detected from the current input image may be determined as a target detection box respectively, and executed.

An image data set to which the object in the target detection box (hereinafter referred to as an object in the detection box) belongs is determined.

Next, the above four categories are taken as the current category respectively, and the sub-loss information that the object is predicted as the current category is determined.

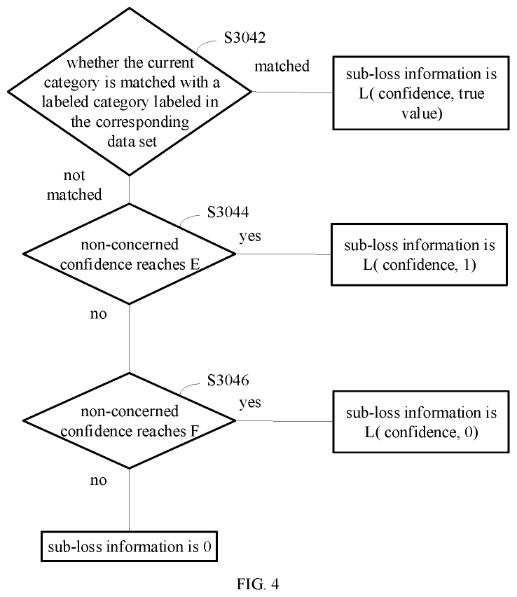

FIG. 4 is a flowchart of a method of determining sub-loss information according to one or more embodiments of the present disclosure.

As shown in FIG. 4, step S3042 may be firstly performed: whether the current category is matched with a labeled category labeled in the corresponding data set is determined. If matched, the sub-loss information may be determined as L (confidence level, true value), where L refers to a preset loss function. The loss function may be a logarithmic loss function, a square loss function, a cross-entropy loss function, or the like. The category of the loss function is not limited herein. L (confidence level, true value) refers to a difference between the confidence level that the object in the detection box determined based on the preset loss function is predicted as the current category and the actual labeling information.

If not matched, step S3044 may be performed: whether a non-concerned confidence level that the object is predicated as the current category reaches a threshold E is determined. If yes, the sub-loss information may be determined as L (confidence level, 1). L (confidence level, 1) refers to a difference between the confidence level that the object in the detection box is predicted as the current category and first reference labeling information.

If the non-concerned confidence level does not reach the threshold E, step S3046 may be further performed: whether the non-concerned confidence level fails to reach a threshold F. If the non-concerned confidence level fails to reach a threshold F, the sub-loss information may be determined as L (confidence level, 0). L (confidence level, 0) refers to a difference between the confidence level that the object in the detection box is predicted as the current category and second reference labeling information.

If the non-concerned confidence level reaches the threshold F, the sub-loss information may be determined as 0.

After the above steps are completed for the images input into the data set 1 and the data set 2, the loss information corresponding to detection of each input image may be obtained, and then, the total loss information may be determined by performing summing or averaging, or the like.

Finally, step S306 may be performed by a parameter adjusting unit: the network parameter of the detection network is adjusted based on the total loss information and the stochastic gradient descent algorithm.

Finally, the above iterative process may be repeated until the detection network converges to complete training.

In the above example, one the one hand, when the object is predicted as the non-labeled category, the reference labeling information of the object is determined according to the corresponding non-concerned confidence level, and thus, more accurate loss information is determined and more accurate information is provided to the network training, thereby improving the network detection accuracy.

In the above example, on the other hand, the corresponding loss information is determined as 0 only when the object is the difficult sample. Compared with the related arts, the cases that the loss information is determined as 0 is reduced, thereby reducing the introduction of inaccurate information and reduce the misreporting rate of the detection network.

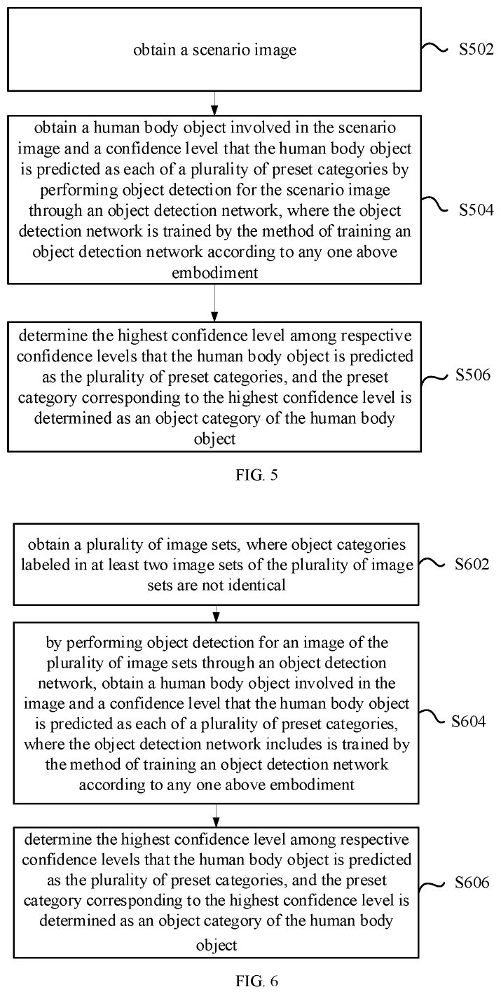

The present disclosure further provides a method of detecting a human body object. FIG. 5 is a flowchart of a method of detecting a human body object according to one or more embodiments of the present disclosure.

As shown in FIG. 5, the method may include the following steps.

At step S502, a scenario image is obtained.

At step S504, a human body object involved in the scenario image and a confidence level that the human body object is predicted as each of a plurality of preset categories is obtained by performing object detection for the scenario image through an object detection network, where the object detection network is trained by the method of training an object detection network according to any one above embodiment.

At step S506, the highest confidence level among respective confidence levels that the human body object is predicted as the plurality of preset categories is determined, and the preset category corresponding to the highest confidence level is determined as an object category of the human body object.

The above scenario may be any scenario in which a human body object is to be detected. For example, the above scenario may be a scenario in which a dangerous driving behavior is detected. At this time, a human body object appearing in a captured scenario image may be detected and matched to determine whether the dangerous behavior occurs. For another example, the above scenario may be a table game scenario. At this time, a human body object appearing in a captured scenario image may be detected and associated to determine an executor who performs actions such as placing chips.

In some examples, the human body object and the preset category may be set according to service requirements. In some examples, the human body object may include at least one of face, hand, elbow, shoulder, leg and torso. The preset category may include at least one of face category, hand category, elbow category, shoulder category, leg category, torso category and background category. Therefore, a plurality of human body categories appearing in the images may be detected to adapt to more service scenarios.

In the above examples, object detection is performed for the scenario image by the object detection network trained by the method of training an object detection network according to any one above embodiment. Therefore, the detection accuracy of the human body object in the image may be improved.

The present disclosure further provides a method of detecting a human body object. FIG. 6 is a flowchart of a method of detecting a human body object according to one or more embodiments of the present disclosure.

At step S602, a plurality of image sets are obtained, where object categories labeled in at least two of the plurality of image sets are not identical.

At step S604, by performing object detection for an image of the plurality of image sets through an object detection network, a human body object involved in the image and a confidence level that the human body object is predicted as each of a plurality of preset categories is obtained, where the object detection network includes is trained by the method of training an object detection network according to any one above embodiment.

At step S606, the highest confidence level among respective confidence levels that the human body object is predicted as the plurality of preset categories is determined, and the preset category corresponding to the highest confidence level is determined as an object category of the human body object.

The image data set may include a plurality of labeled image samples. The object categories labeled in the image may include only some of the various preset categories. For example, if the various preset categories include face category, hand category, elbow category and background category, the object categories labeled in the image may be only face category or hand category.

In the above example, object detection is performed for the image in the image set by the object detection network trained by the method of training an object detection network according to any one above embodiment.

The object detection network may be trained by using an image data set having partial labeled object categories. In addition, an object detection network for a plurality of object categories may be trained by fusing a plurality of image data sets having labeling information of different object categories among them, so as to reduce the training costs.

Corresponding to any one above embodiment, the present disclosure further provides an apparatus for training an object detection network.

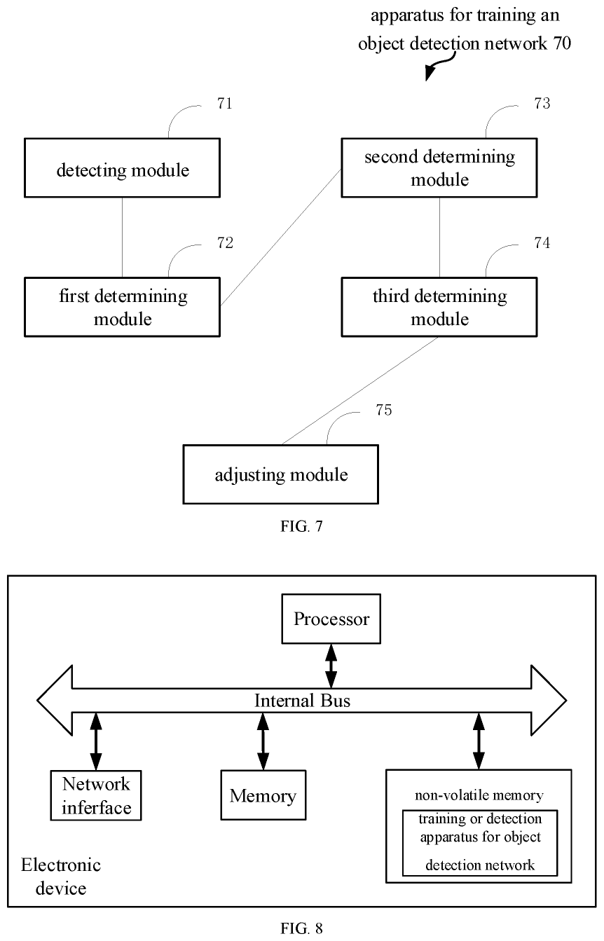

FIG. 7 is a structural schematic diagram of an apparatus for training an object detection network according to one or more embodiments of the present disclosure.

As shown in FIG. 7, the apparatus 70 may include: a detecting module 71, configured to obtain, by performing object detection for images in an image data set input into the object detection network and for each of one or more objects involved in each of the images, a confidence level that the object is predicted as each of a plurality of preset categories; a first determining module 72, configured to, determine, according to one or more labeled categories labeled by the image data set among the plurality of preset categories, one or more non-labeled categories unlabeled by the image data set among the plurality of preset categories; a second determining module 73, for each of the objects, according to a non-concerned confidence level that the object is predicted as each of the non-labeled categories, reference labeling information of the object with respect to each of the non-labeled categories; a third determining module 74, configured to, for each of the objects, according to the confidence level that the object is predicted as each of the preset categories, actual labeling information of the object and the reference labeling information of the object with respect to each of the non-labeled categories, loss information that the object is predicted as each of the preset categories; and an adjusting module 75, configured to adjust a network parameter of the object detection network based on the loss information that each of the objects is predicted as each of the preset categories.

In some embodiments, the second determining module 73 is specifically configured to: in response to that the non-concerned confidence level reaches a preset positive sample confidence level, determine the reference labeling information of the object with respect to the non-labeled category as first preset reference labeling information; and in response to that the non-concerned confidence level does not reach a preset negative sample confidence level, determine the reference labeling information of the object with respect to the non-labeled category as second preset reference labeling information, where the positive sample confidence level is not smaller than the negative sample confidence level.

In some embodiments, the second determining module 73 is further configured to: in response to that the non-concerned confidence level reaches the negative sample confidence level but does not reach the positive sample confidence level, determine the reference labeling information as third preset reference labeling information.

In some embodiments, the first determining module 72 is specifically configured to: obtain object categories labeled in the image data set as the labeled categories; for each of the plurality of preset categories, determine the preset category as a current category and determine whether the current category is matched with one of the labeled categories; and in response to determining that the current category is not matched with any of the labeled categories, determine the current category as a non-labeled category.

In some embodiments, the third determining module 74 is specifically configured to: for each of the non-labeled categories, determine first loss information that the object is predicted as the non-labeled category based on a difference between an irrelevant confidence level that the object is predicted as the non-labeled category and the reference labeling information; and for each of the labeled categories, determine second loss information that the object is predicted as the labeled category according to a difference between a confidence level that the object is predicted as the labeled category and the actual labeling information of the object.

In some embodiments, the adjusting module 75 is specifically configured to: for each of the objects, obtain total loss information by determining a sum of the first loss information and the second loss information corresponding to the object; determine a descent gradient in a back propagation process according to the total loss information of each of objects; and adjust the network parameter of the object detection network through back propagation according to the descent gradient.

In some embodiments, a plurality of image data sets are input into the object detection network, and the labeled categories labeled by at least two of the plurality of image data sets are not identical.

The present disclosure further provides an apparatus for detecting a human body object, including: a first obtaining module, configured to obtain a scenario image; a first predicting module, configured to obtain a human body object involved in the scenario image and a confidence level that the human body object is predicted as each of a plurality of preset categories by performing object detection for the scenario image through an object detection network; wherein the object detection network is trained by the network training method according to any one above embodiment; and a first object category determining module, configured to determine the highest confidence level among respective confidence levels that the human body object is predicted as the plurality of preset categories, and determine a preset category corresponding to the highest confidence level as an object category of the human body object.

In some embodiments, the human body object includes at least one of face, hand, elbow, shoulder, leg and torso. The preset category includes at least one of: face category, hand category, elbow category, shoulder category, leg category, torso category and background category.

The present disclosure further provides an apparatus for detecting a human body object, including: a second obtaining module, configured to obtain a plurality of image sets, wherein object categories labeled in at least two of the plurality of image sets are not identical; a second predicting module, configured to by performing object detection for an image of the plurality of image sets through an object detection network, obtain a human body object involved in the image and a confidence level that the human body object is predicted as each of a plurality of preset categories; wherein the object detection network is trained by the network training method according to any one above embodiment; and a second object category determining module, configured to determine the highest confidence level among respective confidence levels that the human body object is predicted as the plurality of preset categories, and determine a preset category corresponding to the highest confidence level as an object category of the human body object.

In some embodiments, the human body object includes at least one of face, hand, elbow, shoulder, leg and torso. The preset category includes at least one of: face category, hand category, elbow category, shoulder category, leg category, torso category and background category.

The embodiments of the apparatus for training an object detection network and the apparatus for detecting a human body object according to the present disclosure may be applied to an electronic device. Correspondingly, the present disclosure provides an electronic device, and the electronic device may include a memory, a processor and computer instructions stored in the memory and run on the processor, where the processor is configured to perform the method according to any one above embodiment.

FIG. 8 is a hardware structural schematic diagram of an electronic device according to one or more embodiments of the present disclosure.

As shown in FIG. 8, the electronic device may include a processor for executing instructions, a network interface for network connection, a memory for storing operation data for the processor, and a non-volatile memory for storing instructions corresponding to the apparatus for training an object detection network or the apparatus for detecting a human body object.

The above apparatus embodiments may be implemented by software or hardware or a combination of software and hardware. With software implementation as an example, the apparatus, as a logical apparatus, is formed by reading the corresponding computer program instructions in the non-volatile memory into the memory for running by the processor of the electronic device where the apparatus is located. From the level of hardware, the electronic device where the apparatus is located in the embodiments may further include other hardware in addition to the processor, the memory, the network interface and the non-volatile memory as shown in FIG. 8, which will not be repeated herein.

As can be understood, the instructions corresponding to the apparatus for training an object detection network or the apparatus for detecting a human body object may also be directly stored in the memory to improve a processing speed, where is not limited herein.

The present disclosure provides a computer readable storage medium, storing computer programs thereon, where the programs are executed by a processor to implement the method according to any one above embodiment.

Persons skilled in the art shall understand that one or more embodiments of the present disclosure may be provided as methods, systems, or computer program products. Thus, one or more embodiments of the present disclosure may be adopted in the form of entire hardware embodiments, entire software embodiments or embodiments combining software and hardware. Further, one or more embodiments of the present disclosure may be adopted in the form of computer program products that are implemented on one or more computer available storage media (including but not limited to magnetic disk memory, CD-ROM, and optical memory and so on) including computer available program codes.

In the present disclosure, the word “and/or” refers to at least one of two. For example, “A and/or B” may include three options: A, B and “A and B”.

Different embodiments in the present disclosure are described in a progressive manner. Each embodiment focuses on the differences from other embodiments with those same or similar parts among the embodiments referred to each other. Particularly, since data processing device embodiments are basically similar to the method embodiments, the device embodiments are briefly described with relevant parts referred to the descriptions of the method embodiments.

Specific embodiments of the present disclosure are described above. Other embodiments not described herein still fall within the scope of the appended claims. In some cases, the actions or steps recorded in the claims may be performed in a sequence different from the embodiments to achieve a desired result. Further, the processes shown in drawings do not necessarily require a particular sequence or a continuous sequence to achieve the desired result. In some embodiments, a multi-task processing and parallel processing is possible and may also be advantageous.

The embodiments of the subject and functional operations described in the present disclosure may be achieved in the following: a digital electronic circuit, a tangible computer software or firmware, a computer hardware including a structure disclosed in the present disclosure or a structural equivalent thereof, or a combination of one or more of the above. The embodiment of the subject described in the present disclosure may be implemented as one or more computer programs, that is, one or more modules in computer program instructions encoded on a tangible non-transitory program carrier for being executed by or controlling a data processing apparatus. Alternatively or additionally, the program instructions may be encoded on an artificially-generated transmission signal, such as a machine-generated electrical, optical or electromagnetic signal. The signal is generated to encode and transmit information to an appropriate receiver for execution by the data processing apparatus. The computer storage medium may be a machine readable storage device, a machine readable storage substrate, a random or serial access memory device, or a combination of one or more of the above.

The processing and logic flows described in the present disclosure may be executed by one or more programmable computers executing one or more computer programs to perform operations based on input data and generate outputs to execute corresponding functions. The processing and logic flows may be further executed by a dedicated logic circuit, such as a field programmable gate array (FPGA) or an application specific integrated circuit (ASIC), and the apparatus may be further implemented as the dedicated logic circuit.

Computers suitable for executing computer programs may include, for example, a general-purpose and/or special-purpose microprocessor, or any other category of central processing unit. Generally, the central processing unit receives instructions and data from a read-only memory and/or random access memory. Basic components of a computer may include a central processing unit for implementing or executing instructions and one or more storage devices for storing instructions and data. Generally, the computer may further include one or more mass storage devices for storing data, such as magnetic disks, magneto-optical disks or optical disks, or the computer is operably coupled to this mass storage device to receive data therefrom or transmit data thereto, or both. However, the computer does not necessarily have such device. In addition, the computer may be embedded in another device, such as a mobile phone, a personal digital assistant (PDA), a mobile audio or video player, a game console, a global positioning system (GPS) receiver, or a portable storage device, e.g., a universal serial bus (USB) flash drive, and so on.

Computer readable media suitable for storing computer program instructions and data may include all forms of non-volatile memories, media and memory devices, such as semi-conductor memory devices (e.g., Erasable Programmable Read-Only Memory (EPROM),Electrically Erasable Programmable Read-Only Memory (EEPROM) and flash memory device), magnetic disks (e.g., internal hard disk or removable disk), magneto-optical disks, and CD ROM and DVD-ROM disks. The processor and the memory may be supplemented by or incorporated into a dedicated logic circuit.

Although many specific implementation details are included in the present disclosure, these details should not be construed as limiting any scope of the present disclosure or the claimed scope, but are mainly used to describe the features of specific embodiments of the present disclosure. Certain features described in several embodiments of the present disclosure may also be implemented in combination in a single embodiment. On the other hand, various features described in the single embodiment may also be implemented separately or in any appropriate sub-combination in several embodiments. In addition, although the features may function in certain combinations as described above and even be initially claimed as such, one or more features from the claimed combination may be removed from the combination in some cases, and the claimed combination may refer to a sub-combination or a variation of the sub-combination.

Similarly, although the operations are described in a specific order in the drawings, this should not be understood as requiring these operations to be performed in the shown specific order or in sequence, or requiring all of the illustrated operations to be performed, so as to achieve a desired result. In some cases, multi-task processing and parallel processing may be advantageous. In addition, the separation of different system modules and components in the above embodiments should not be understood as requiring such separation in all embodiments. Further, it is to be understood that the described program components and systems may be generally integrated together in a single software product or packaged into a plurality of software products.

Therefore, the specific embodiments of the subject are already described, and other embodiments are within the scope of the appended claims. In some cases, actions recorded in the claims may be performed in a different order to achieve the desired result. In addition, the processing described in the drawings is not necessarily performed in the shown specific order or in sequence, so as to achieve the desired result. In some implementations, multi-task processing and parallel processing may be advantageous.

The foregoing disclosure is merely illustrative of preferred embodiments of the present disclosure but not intended to limit the present disclosure, and any modifications, equivalent substitutions, adaptations thereof made within the spirit and principles of one or more embodiments in the present disclosure shall be encompassed in the scope of protection of one or more embodiments in the present disclosure.

1. A method, comprising:
training an object detection network by
obtaining, by performing object detection for images in an image data set input into the object detection network and for each of one or more objects involved in each of the images, a confidence level that the object is predicted as each of a plurality of preset categories, wherein the plurality of preset categories comprise one or more labeled categories labeled by the image data set and one or more non-labeled categories unlabeled by the image data set;
for each of the objects, according to a non-concerned confidence level that the object is predicted as each of the non-labeled categories, determining reference labeling information of the object with respect to each of the non-labeled categories;
for each of the objects, according to the confidence level that the object is predicted as each of the preset categories, actual labeling information of the object and the reference labeling information of the object with respect to each of the non-labeled categories, determining loss information that the object is predicted as each of the preset categories; and
adjusting a network parameter of the object detection network based on the loss information that each of the objects is predicted as each of the preset categories.

2. The method according to claim 1, wherein determining the reference labeling information of the object with respect to the non-labeled category according to the non-concerned confidence level that the object is predicted as the non-labeled category comprises:
in response to that the non-concerned confidence level reaches a preset positive sample confidence level, determining the reference labeling information of the object with respect to the non-labeled category as first preset reference labeling information; and
in response to that the non-concerned confidence level does not reach a preset negative sample confidence level, determining the reference labeling information of the object with respect to the non-labeled category as second preset reference labeling information;
wherein the positive sample confidence level is not smaller than the negative sample confidence level.

3. The method according to claim 2, further comprising:
in response to that the non-concerned confidence level reaches the negative sample confidence level but does not reach the positive sample confidence level, determining the reference labeling information of the object with respect to the non-labeled category as third preset reference labeling information.

4. The method according to claim 1, wherein the labeled categories and the non-labeled categories are determined by:
obtaining object categories labeled in the image data set as the labeled categories;
for each of the plurality of preset categories, determining the preset category as a current category by:
determining whether the current category is matched with one of the labeled categories; and
in response to determining that the current category is not matched with any of the labeled categories, determining the current category as a non-labeled category.

5. The method according to claim 1, wherein according to the confidence level that the object is predicted as each of the preset categories, actual labeling information of the object and the reference labeling information of the object with respect to each of the non-labeled categories, determining the loss information that the object is predicted as each of the preset categories comprises:
for each of the non-labeled categories, determining first loss information that the object is predicted as the non-labeled category based on a difference between a non-concerned confidence level that the object is predicted as the non-labeled category and the reference labeling information of the object with respect to the non-labeled category; and
for each of the labeled categories, determining second loss information that the object is predicted as the labeled category according to a difference between a confidence level that the object is predicted as the labeled category and the actual labeling information of the object.

6. The method according to claim 5, wherein adjusting the network parameter of the object detection network based on the loss information that each of the objects is predicted as each of the preset categories comprises:
for each of the objects, obtaining total loss information by determining a sum of the first loss information and the second loss information corresponding to the object;
determining a descent gradient in a back propagation process according to the total loss information of each of the objects; and
adjusting the network parameter of the object detection network through back propagation according to the descent gradient.

7. The method according to claim 1, wherein
a plurality of image data sets are input into the object detection network, and
the labeled categories labeled by at least two of the plurality of image data sets are not identical.

8. The method of claim 1, further comprising detecting a human body object comprising:
obtaining a scenario image;
obtaining a human body object involved in the scenario image and a confidence level that the human body object is predicted as each of a plurality of preset categories by performing object detection for the scenario image through the object detection network;
determining a highest confidence level among respective confidence levels that the human body object is predicted as each of the plurality of preset categories, and
determining a preset category corresponding to the highest confidence level as an object category of the human body object.

9. The method according to claim 8, wherein
the human body object comprises at least one of face, hand, elbow, shoulder, leg and torso;
the preset category comprises at least one of: face category, hand category, elbow category, shoulder category, leg category, torso category and background category.

10. The method of claim 1, further comprising detecting a human body object comprising:
obtaining a plurality of image sets, wherein object categories labeled in at least two of the plurality of image sets are not identical;
by performing object detection for an image of the plurality of image sets through an object detection network, obtaining a human body object involved in the image and a confidence level that the human body object is predicted as each of a plurality of preset categories;
determining a highest confidence level among respective confidence levels that the human body object is predicted as each of the plurality of preset categories; and
determining a preset category corresponding to the highest confidence level as an object category of the human body object.

11.-16. (canceled)

17. An electronic device, comprising:
at least one processor; and
at least one non-transitory machine readable storage medium coupled to the at least one processor having machine-executable instructions stored thereon that, when executed by the at least one processor, cause the at least one processor to perform operations comprising:
training an object detection network by
obtaining, by performing object detection for images in an image data set input into the object detection network and for each of one or more objects involved in each of the images, a confidence level that the object is predicted as each of a plurality of preset categories, wherein the plurality of preset categories comprise one or more labeled categories labeled by the image data set and one or more non-labeled categories unlabeled by the image data set;
for each of the objects, according to a non-concerned confidence level that the object is predicted as each of the non-labeled categories, determining reference labeling information of the object with respect to each of the non-labeled categories;
for each of the objects, according to the confidence level that the object is predicted as each of the preset categories, actual labeling information of the object and the reference labeling information of the object with respect to each of the non-labeled categories, determining loss information that the object is predicted as each of the preset categories; and
adjusting a network parameter of the object detection network based on the loss information that each of the objects is predicted as each of the preset categories.

18. The electronic device according to claim 17, wherein determining the reference labeling information of the object with respect to the non-labeled category according to the non-concerned confidence level that the object is predicted as the non-labeled category comprises:
in response to that the non-concerned confidence level reaches a preset positive sample confidence level, determining the reference labeling information of the object with respect to the non-labeled category as first preset reference labeling information; and
in response to that the non-concerned confidence level does not reach a preset negative sample confidence level, determining the reference labeling information of the object with respect to the non-labeled category as second preset reference labeling information;
wherein the positive sample confidence level is not smaller than the negative sample confidence level.

19. The electronic device according to claim 18, the operations further comprising:
in response to that the non-concerned confidence level reaches the negative sample confidence level but does not reach the positive sample confidence level, determining the reference labeling information of the object with respect to the non-labeled category as third preset reference labeling information.

20. The electronic device according to claim 17, wherein the labeled categories and the non-labeled categories are determined by
obtaining object categories labeled in the image data set as the labeled categories;
for each of the plurality of preset categories, determining the preset category as a current category by
determining whether the current category is matched with one of the labeled categories; and
in response to determining that the current category is not matched with any of the labeled categories, determining the current category as a non-labeled category.

21. The electronic device according to claim 17, wherein according to the confidence level that the object is predicted as each of the preset categories, actual labeling information of the object and the reference labeling information of the object with respect to each of the non-labeled categories, determining the loss information that the object is predicted as each of the preset categories comprises:
for each of the non-labeled categories, determining first loss information that the object is predicted as the non-labeled category based on a difference between a non-concerned confidence level that the object is predicted as the non-labeled category and the reference labeling information of the object with respect to the non-labeled category; and
for each of the labeled categories, determining second loss information that the object is predicted as the labeled category according to a difference between a confidence level that the object is predicted as the labeled category and the actual labeling information of the object.

22. The electronic device according to claim 21, wherein adjusting the network parameter of the object detection network based on the loss information that each of the objects is predicted as each of the preset categories comprises:
for each of the objects, obtaining total loss information by determining a sum of the first loss information and the second loss information corresponding to the object;
determining a descent gradient in a back propagation process according to the total loss information of each of the objects; and
adjusting the network parameter of the object detection network through back propagation according to the descent gradient.

23. The electronic device according to claim 17, wherein
a plurality of image data sets are input into the object detection network, and
the labeled categories labeled by at least two of the plurality of image data sets are not identical.

24. The electronic device according to claim 17, the operations further comprising detecting a human body object comprising:
obtaining a scenario image;
obtaining a human body object involved in the scenario image and a confidence level that the human body object is predicted as each of a plurality of preset categories by performing object detection for the scenario image through the object detection network;
determining a highest confidence level among respective confidence levels that the human body object is predicted as each of the plurality of preset categories, and
determining a preset category corresponding to the highest confidence level as an object category of the human body object.

25. The electronic device according to claim 17, the operations further comprising detecting a human body object comprising:
obtaining a plurality of image sets, wherein object categories labeled in at least two of the plurality of image sets are not identical;
by performing object detection for an image of the plurality of image sets through an object detection network, obtaining a human body object involved in the image and a confidence level that the human body object is predicted as each of a plurality of preset categories;
determining a highest confidence level among respective confidence levels that the human body object is predicted as each of the plurality of preset categories; and
determining a preset category corresponding to the highest confidence level as an object category of the human body object.

26. A non-transitory computer-readable storage medium coupled to at least one processor and storing programming instructions for execution by the at least one processor, wherein the programming instructions instruct the at least one processor to perform operations comprising:
training an object detection network by
obtaining, by performing object detection for images in an image data set input into the object detection network and for each of one or more objects involved in each of the images, a confidence level that the object is predicted as each of a plurality of preset categories, wherein the plurality of preset categories comprise one or more labeled categories labeled by the image data set and one or more non-labeled categories unlabeled by the image data set;
for each of the objects, according to a non-concerned confidence level that the object is predicted as each of the non-labeled categories, determining reference labeling information of the object with respect to each of the non-labeled categories;
for each of the objects, according to the confidence level that the object is predicted as each of the preset categories, actual labeling information of the object and the reference labeling information of the object with respect to each of the non-labeled categories, determining loss information that the object is predicted as each of the preset categories; and
adjusting a network parameter of the object detection network based on the loss information that each of the objects is predicted as each of the preset categories.
